(19) United States
(12) Patent Application Publication
(10) Pub. No.: US 2021/0199798 A1
(43) Pub. Date: Jul. 1, 2021

(54) CONTINUOUS WAVE RADAR TERRAIN PREDICTION METHOD, DEVICE, SYSTEM, AND UNMANNED AERIAL VEHICLE

(71) Applicant: SZ DJI TECHNOLOGY CO., LTD., Shenzhen (CN)

(72) Inventors: Huangjian ZHU, Shenzhen (CN); Di GAO, Shenzhen (CN); Chunming WANG, Shenzhen (CN); Hongshi TAN, Shenzhen (CN)

(21) Appl. No.: 17/183,315

(22) Filed: Feb. 23, 2021

Related U.S. Application Data
(63) Continuation of application No. PCT/CN2018/102628, filed on Aug. 28, 2018.

(51) Int. Cl. G01S 13/935; G05D 1/10

(52) U.S. Cl. CPC G01S 13/935; G05D 1/106

(57) ABSTRACT

A terrain prediction method includes obtaining N pieces of ranging data obtained by a continuous wave radar performing ranging on ground during rotation and when a rotation angle of the continuous wave radar is in a predetermined angle range, excluding outliers from the N pieces of ranging data to obtain M pieces of ranging data, and determining a terrain parameter of the ground according to the M pieces of ranging data. N is an integer greater than 1. M is a positive integer smaller than N. The terrain parameter includes at least one of a slope, a flatness, or a height value of the continuous wave radar to the ground directly below.

### CROSS-REFERENCE TO RELATED APPLICATION

This application is a continuation of International Application No. PCT/CN2018/102628, filed Aug. 28, 2018, the entire content of which is incorporated herein by reference.

### TECHNICAL FIELD

The present disclosure generally relates to the unmanned aerial vehicle (UAV) technology field and, more particularly, to a continuous wave radar terrain prediction method, a device, a system, and a UAV.

### BACKGROUND

Currently, an unmanned aerial vehicle (UAV) is applied in a plurality of scenarios. For example, in agriculture, the UAV is used to cultivate land, sow, spray pesticides, harvest crops, etc., which brings a great benefit to the agricultural field. In these operational scenarios, the UAV needs to fly close to the ground and avoid accidentally hitting the ground while climbing. When the ground is flat, based on data of a global positioning system (GPS) and an inertial measurement unit (IMU), the UAV can smoothly complete the tasks above. When the terrain is rugged, the UAV needs adjust in advance to perform operations of climbing, descending, deceleration, braking, etc. to fly close to the ground or even fly at an even height. As such, the UAV can better complete the tasks. Therefore, terrain information of the ground where the UAV is operated needs to be predicted.

In the existing technology, a plurality of distances to the ground are measured by rotating a continuous wave radar. The distances are converted into coordinates of a coordinate system by using a ranging sensor as an origin. A straight line is then fitted by using these coordinates. The terrain information of the ground is obtained according to the fitted straight line. However, in an actual situation, interference of an internal environment and an external environment of a continuous wave radar can cause outliers to be included in the distances measured by the continuous wave radar, which impacts accuracy of terrain prediction.

### SUMMARY

In accordance with the disclosure, there is provided a terrain prediction method including obtaining N pieces of ranging data obtained by a continuous wave radar performing ranging on ground during rotation and when a rotation angle of the continuous wave radar is in a predetermined angle range, excluding outliers from the N pieces of ranging data to obtain M pieces of ranging data, and determining a terrain parameter of the ground according to the M pieces of ranging data. N is an integer greater than 1. M is a positive integer smaller than N. The terrain parameter includes at least one of a slope, a flatness, or a height value of the continuous wave radar to the ground directly below.

### BRIEF DESCRIPTION OF THE DRAWINGS

FIG. 1 is a schematic architecture diagram of an agricultural unmanned aerial vehicle (UAV) according to some embodiments of the present disclosure.

FIG. 2 is a schematic flowchart of a continuous wave radar terrain prediction method according to some embodiments of the present disclosure.

FIG. 3 is a schematic diagram showing ranging of a continuous wave radar according to some embodiments of the present disclosure.

FIG. 4 is a schematic diagram showing the ranging of the continuous wave radar within a predicted angle range according to some embodiments of the present disclosure.

FIG. 5A-5F are schematic diagrams showing excluding outliers according to some embodiments of the present disclosure.

FIG. 6A is a schematic diagram showing a fitted straight line obtained according to N pieces of first ranging data without excluding the outliers according to some embodiments of the present disclosure.

FIG. 6B is a schematic diagram showing a fitted straight line obtained according to M pieces of first ranging data after the outliers are excluded according to some embodiments of the present disclosure.

FIG. 7 is a schematic structural diagram of a control system of the continuous wave radar according to some embodiments of the present disclosure.

FIG. 8 is a schematic structural diagram of a radar detection device according to some embodiments of the present disclosure.

FIG. 9 is a schematic structural diagram of a UAV according to some embodiments of the present disclosure.

### DETAILED DESCRIPTION OF THE EMBODIMENTS

To make purposes, technical solutions, and advantages of embodiments of the present disclosure clearer, embodiments of the present disclosure are described in detail in connection with the accompanying drawings. Described embodiments are some embodiments of the present disclosure, not all embodiments. Based on embodiments of the present disclosure, all other embodiments obtained by those of ordinary skill in the art without creative efforts are within the scope of the present disclosure.

Embodiments of the present disclosure provide a continuous wave radar terrain prediction method, a device, a system, and an unmanned aerial vehicle (UAV). The UAV may include an agricultural UAV, such as a rotorcraft, for example, a multi-rotor aircraft propelled by a plurality of propulsion devices through air. Embodiments of the present disclosure are not limited to this.

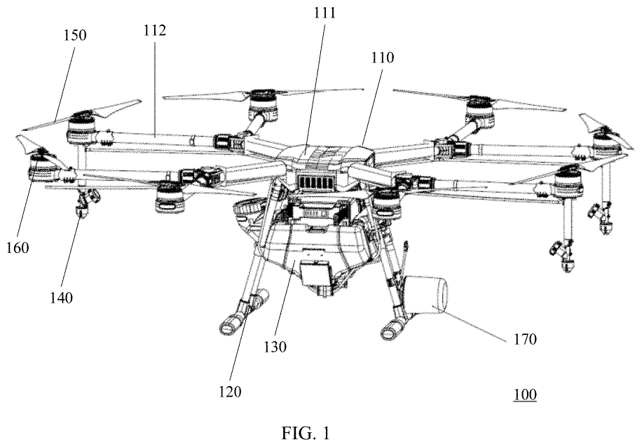

FIG. 1 is a schematic architecture diagram of an agricultural UAV 100 according to some embodiments of the present disclosure. The rotorcraft is described as an example in embodiments of the present disclosure.

The agricultural UAV 100 includes a propulsion system, a flight control system, and a vehicle frame. The agricultural UAV 100 may communicate with a control terminal wirelessly. The control terminal may be configured to display flight information of the agricultural UAV 100, communicate with the agricultural UAV 100 wirelessly, and operate the agricultural UAV 100 remotely.

The vehicle frame includes a vehicle body 110 and a stand 120 (landing gear). The vehicle body 110 includes a center frame 111 and one or more vehicle arms 112 connected to the center frame 111. The one or more vehicle arms 112 extend from the center frame 111 radially. The stand 120 is connected to the vehicle body 110 and may be configured to support the agricultural UAV 100 when the agricultural UAV 100 is landed. A liquid storage tank 130 is carried between stands 120. The liquid storage tank 130 may be configured to store pesticides or water. A spray head 140 is arranged at an end of the vehicle arm 112. The liquid of the liquid storage tank 130 may be pumped to the spray head 140 by a pump and sprayed out by the spray head 140.

The propulsion system may include one or more electronic speed controllers (ESC), one or more propellers 150, and one or more motors 160 corresponding to the one or more propellers 150. A motor 160 is connected between an ESC and a propeller 150. The motor 160 and the propeller 150 are arranged at a vehicle arm 112 of the agricultural UAV 100. The ESC may be configured to receive a drive signal generated by the flight control system and provide a drive current to the motor according to the drive signal to control the rotation speed of the motor 160. The motor 160 may be configured to drive the propeller 150 to rotate to provide power for the flight of the agricultural UAV 100. The power may cause the agricultural UAV 100 to realize motions of one or more degrees of freedom. In some embodiments, the agricultural UAV 100 may rotate around one or more rotation axes. For example, the rotation axes may include a roll axis, a yaw axis, and a pitch axis. The motor 160 may include a direct current (DC) motor or an alternative current (AC) motor. In addition, the motor 160 may include a brushless motor or a brushed motor.

The flight control system may include a flight controller and a sensor system. The sensor system may be configured to measure attitude information of the UAV, that is, position information and status information of the agricultural UAV 100 in space, for example, a three-dimensional (3D) position, a 3D angle, a 3D speed, a 3D acceleration, and a 3D angular speed. The sensor system, for example, may include at least one of a gyroscope, an ultrasound sensor, an electronic compass, an inertial measurement unit (IMU), a vision sensor, a global navigation satellite system, or a barometer. For example, the global navigation satellite system may include a global positioning system (GPS). The flight controller may be configured to control the flight of the agricultural UAV 100, for example, control the flight of the agricultural UAV 100 according to the attitude information measured by the sensor system. The flight controller may be configured to control the agricultural UAV 100 according to pre-coded program instructions or by responding to one or more control instructions from the control terminal.

As shown in FIG. 1, the stand 120 of the agricultural UAV carries a continuous wave radar 170. The continuous wave radar 170 may include a rotation continuous wave radar. The continuous wave radar 170 may be configured for ranging but not limited to ranging. The agricultural UAV may include two or more than two stands 170. The continuous wave radar 170 may be arranged at one of the stands 170.

Names of components of the agricultural UAV are given for a purpose of identification and shall not be considered as a limitation to embodiments of the present disclosure.

FIG. 2 is a schematic flowchart of a continuous wave radar terrain prediction method according to some embodiments of the present disclosure. As shown in FIG. 2, the method of embodiments of the present disclosure includes the following processes.

At S201, N pieces of first ranging data, which are obtained by the continuous wave radar measuring a distance to the ground during rotation, are obtained. The N pieces of first ranging data are obtained when a rotation angle of the continuous wave radar is in a predetermined angle range.

At S202, outliers are excluded from the N pieces of first ranging data to obtain M pieces of first ranging data.

At S203, according to the N pieces of first ranging data, a terrain parameter of the ground is determined. The terrain parameter may include at least one of a slope, a flatness, or a height value of the continuous wave radar to the ground directly below.

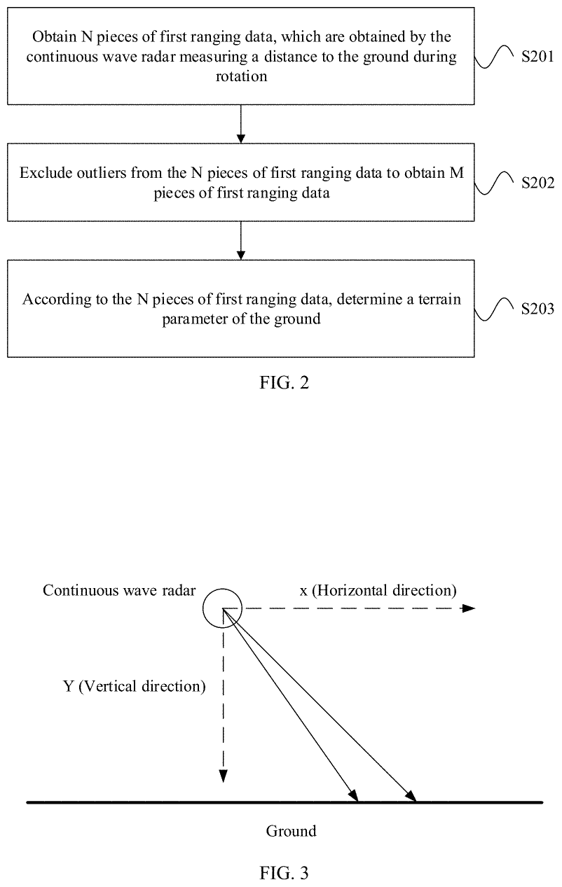

In some embodiments, the continuous wave radar may be configured to perform ranging on the ground to obtain the distance of the continuous wave radar to the ground. The continuous wave radar may rotate. When the continuous wave radar rotates to different angles, the ranging points where the continuous wave radar performs ranging on the ground may be different. Thus, as shown in FIG. 3, the distances to the ground detected by the continuous wave radar may be different. In some embodiments, when the continuous wave radar performs ranging on the ground during rotation, and the rotation angle of the continuous wave radar is in a predetermined angle range, a plurality of pieces of first ranging data may be obtained. For example, as shown in FIG. 4, the N pieces of first ranging data are obtained, wherein N is an integer greater than or equal to 2. Each piece of first ranging data may reflect the distance of the continuous wave radar to the ground when the continuous wave radar rotates to a corresponding rotation angle. For a same ranging point, if the ground where the ranging point is located is high, the distance of the continuous wave radar to the ground may be small. If the ground where the ranging point is located is low, the distance of the continuous wave radar to the ground may be large. For example, if the differences between the distances of the continuous wave radar to the different ranging points are relatively large, the flatness of the ground may be low. For a same set of the plurality of ranging points, if the distances of the continuous wave radar to the ground are relatively small, the slope of the ground where the plurality of ranging points are located may be large. If the distances of the continuous wave radar to the ground are relatively large, the slope of the ground where the plurality of ranging points are located is relatively small.

In the actual situation, the interference of internal and external environments of the continuous wave radar may cause outliers to exist in the distances measured by the continuous wave radar. For example, for a ranging point having a large actual distance to the ranging point, the continuous wave radar may be interfered to cause the corresponding first ranging data to be small. Thus, the measured slope of the terrain may have a large error as compared to the actual slope. For example, in a complex application scenario such as an agricultural field or a tea mountain, the outliers may cause the terrain prediction to be inaccurate.

Therefore, in some embodiments, the outliers may be excluded from the N pieces of first ranging data to obtain the M pieces of first ranging data. M is a positive integer smaller than N. The terrain parameter of the ground where the plurality of ranging points are located may be determined according to the plurality of pieces of first ranging data without the outliers. The terrain parameter may include the slope of the ground, the flatness of the ground, and the height value of the continuous wave radar to the ground directly below.

For example, a predetermined angle range from 60° to 120° can be used for determining the terrain parameter of the ground directly below the continuous wave radar, a predetermined angle range from −30° to 30° can be used for determining the terrain parameter of the ground in front of the continuous wave radar, and a predetermined angle range from 150° to 210° can be used for determining the terrain parameter of the ground behind the continuous wave radar. The examples are described for illustration and do not limit embodiments of the present disclosure. The predetermined angle range may be set according to actual needs. For example, the predetermined angle range is from 60° to 120°, the continuous wave radar may perform ranging on the ground when the rotation angle is 60° to obtain the first ranging data, perform ranging on the ground at 60.6° to obtain the first ranging data, perform ranging on the ground at 61.2° to obtain the first ranging data, and perform ranging on the ground at 61.8° to obtain the first ranging data, and so on.

In some embodiments, the N pieces of first ranging data, which are obtained by performing ranging on the ground when the continuous wave radar rotates to the predetermined angle range during rotation, may be obtained. Then, the M pieces of first ranging data may be obtained by excluding the outliers from the N pieces of first ranging data. Then, the terrain parameter of the ground may be determined according to the M pieces of first ranging data, for example, the slope, the flatness, the height value of the continuous wave radar to the ground directly below. In embodiments of the present disclosure, since the outliers are excluded from the obtained ranging data to predict the terrain, the interference on the continuous wave radar may be eliminated, which enables the continuous wave radar to predict the terrain of the ground more accurately.

Each piece of first ranging data may include a horizontal distance of the continuous wave radar to the ranging point of the ground and a vertical distance of the continuous wave radar to the ranging point of the ground. With different rotation angles of the continuous wave radar, signal transmission directions of the continuous wave radar may be different. Thus, the ranging points of the ground may be different. Therefore, the ranging points of the ground may be different with different rotation angles of the continuous wave radar. In some embodiments, to avoid inaccurate terrain prediction caused by a same distance value between the continuous wave radar and the ranging points of the ground obtained on different terrains of the ground, the first ranging data of embodiments of the present disclosure may include the horizontal distance and the vertical distance. The horizontal distance and the vertical distance may be obtained according to the distance of the continuous wave radar to the ranging point of the ground and the rotation angle of the continuous wave radar corresponding to the ranging point of the ground. For example, for the same distance between the continuous wave radar and the ranging points of the ground, if the horizontal distance of the continuous wave radar to the ranging point of the ground is larger and the vertical distance is smaller, the slope of the ground may be smaller.

In some embodiments, process S201 includes obtaining T pieces of second ranging data by the continuous wave radar performing ranging on the ground during the rotation and obtaining the N pieces of first ranging data according to the T pieces of second ranging data. The T pieces of second ranging data are all pieces of ranging data of the continuous wave radar performing ranging on the ground when the rotation angle is in the predetermined angle range. T is an integer greater than or equal to N.

In some embodiments, all the pieces of ranging data, which are obtained by the continuous wave radar performing ranging on the ground during rotation when the rotation angle of the continuous wave radar is in the predetermined angle range, may be obtained. These ranging data are referred to as the T pieces of second ranging data.

In some embodiments, obtaining the T pieces of second ranging data includes obtaining all the pieces of second ranging data by the continuous wave radar performing ranging on the ground when the continuous wave radar rotates a revolution and rotation angles of the continuous wave radar corresponding to the pieces of second ranging data, and obtaining the second ranging data corresponding to the rotation angle of the continuous wave radar in the predetermined angle range as the T pieces of second ranging data according to the predetermined angle range.

In some embodiments, the continuous wave radar rotates for one revolution means the continuous wave radar rotates for 360°. For example, rotation of one revolution by the continuous wave radar corresponds to 600 optical grids. In this example, each time the continuous wave radar rotates by 0.6°, the continuous wave radar rotates to a corresponding optical grid, and ranging is triggered for once. As such, 600 pieces of ranging data may be obtained. In addition, the rotation angle of the continuous wave radar corresponding to each piece of ranging data may be recorded in embodiments of the present disclosure. A plurality of pieces of second ranging data corresponding to the rotation angles of the continuous wave radar in the predetermined angle range are obtained. For example, the predetermined angle range may be from 60° to 120°, thus, the second ranging data corresponding to 60°, 60.6°, 61.2°, . . . , 118.8°, 119.4°, and 120° may be obtained. 100 pieces of second ranging data may be obtained here. That is, T may be equal to 100.

In some embodiments, the second ranging data may include data obtained by the continuous wave radar actually performing ranging. After the T pieces of second ranging data are obtained, the N pieces of first ranging data may be obtained according to the T pieces of second ranging data.

In some embodiments, obtaining the N pieces of first ranging data according to the T pieces of second ranging data may include determining the N pieces of first ranging data according to the T pieces of second ranging data and an effective ranging condition. The effective ranging condition may include being smaller than or equal to a maximum distance and greater than or equal to a minimum distance.

In some embodiments, effectiveness of the ranging data may be determined every time. The continuous wave radar may include a blind zone in a close distance range and a maximum ranging distance. Thus, the effective ranging condition may be set. The effective ranging condition may be represented by [dₘᵢₙ, dₘₐₓ], that is, the effective second ranging data should be greater than or equal to dₘᵢₙ and smaller than or equal to dₘₐₓ. Therefore, in embodiments of the present disclosure, according to the T pieces of second ranging data and the effective ranging condition, the N pieces of first ranging data may be determined. As such, an error of the ranging data can be avoided to improve the accuracy of the terrain prediction of the ground.

In some embodiments, determining the N pieces of first ranging data according to the T pieces of second ranging data and the effective ranging condition may include determining N pieces of second ranging data that meets the effective ranging condition, from among the T pieces of second ranging data, and determining the N pieces of first ranging data according to the N pieces of second ranging data.

In some embodiments, all the pieces of second ranging data that are smaller than or equal to the predetermined maximum distance and greater than or equal to the predetermined minimum distance may be determined from the T pieces of second ranging data. These second ranging data are the N pieces of second ranging data.

In some embodiments, the N pieces of first ranging data may be determined according to the determined N pieces of second ranging data that meet the effective ranging condition.

In some embodiments, the N pieces of second ranging data may be determined as the N pieces of first ranging data, that is, the first ranging data may be equal to the second ranging data.

In some other embodiments, smoothing may be performed on the N pieces of second ranging data to obtain the N pieces of first ranging data. For example, according to an order of the rotation angle of the continuous wave radar corresponding to the second ranging data, the N pieces of second ranging data may be sorted. For example, a first piece of second ranging data may include second ranging data d₁ corresponding to 60°, a second piece of second ranging data may include second ranging data d₂ corresponding to 60.6°, and so on so forth. Then, the first piece of second ranging data may be determined as a first piece of first ranging data, that is, D₁ may be equal to d₁, and the N-th piece of second ranging data may be determined as the N-th piece of first ranging data, that is, D_{N} may be equal to d_{N}. An average value of a (j−1)-th piece of second ranging data (e.g., dⱼ₋₁), a j-th piece of second ranging data (e.g., dⱼ), and a (j+1)-th piece of second ranging data (e.g., dⱼ₊₁) may be equal to the j-th piece of first ranging data. j is an integer greater than or equal to 2 and smaller than or equal to N−1, that is, Dⱼ=[dⱼ₋₁+dⱼ+dⱼ₋₁]3.

Dⱼ may not be limited to the average value of dⱼ and each one piece of left and right second ranging data neighboring to dⱼ (i.e., three pieces of second ranging data), and may also be equal to an average value of dⱼ and each two pieces of left and right second ranging data neighboring to dⱼ (i.e., five pieces of second ranging data). Correspondingly, the first and second pieces of the first ranging data may be equal to the first and second pieces of the second ranging data, respectively. The (N−1)-th and N-th pieces of the first ranging data may be equal to the (N−1)-th and N-th pieces of the second ranging data, respectively. In addition, in some embodiments, each three or four of left and right second ranging data neighboring to dⱼ may be used to calculate Dⱼ. The solution is similar and the description thereof is repeated.

In addition, dⱼ may include a value, that is, the distance between the continuous wave radar and the ranging point of the ground. In some embodiments, after the smooth processing is performed, a horizontal distance xⱼ and a vertical distance yⱼ of the corresponding first ranging data may be obtained according to the rotation angle corresponding to the continuous wave radar. A rotation center of the continuous wave radar may be used as an origin (0, 0) of a coordinate system (XOY). A forward direction of the continuous wave radar may be along a positive direction of X-axis, and a vertically downward direction may be along a positive direction of Y-axis. x may represent a horizontal distance, y may represent a vertical distance, and x may include a positive value or a negative value.

In addition, dⱼ may include two values, that is, the horizontal distance xⱼ and the vertical distance yⱼ between the continuous wave radar and the ranging point of the ground. In some embodiments, the smooth processing may be performed on the horizontal distance to obtain a horizontal distance of the first ranging data. The smooth processing may be also performed on the vertical distance to obtain a vertical distance of the first ranging data.

If the continuous wave radar measures a straight-line distance between the continuous wave radar and the ranging point of the ground, after the straight-line distance Lᵢ between the continuous wave radar and the ranging point of the ground, the ranging data (Lᵢ) of the continuous wave radar and a corresponding optical grid (Gᵢ) may be converted into a piece of first ranging data, i.e., coordinates in the coordinate system:

xᵢ=Lᵢ*sin((G0−Gᵢ)/Z)

yᵢ=Lᵢ*cos((G0−Gᵢ)/Z)

where G0 denotes a grating scale directly below the continuous wave radar, and Z denotes an angle corresponding to a single optical grid.

In some embodiments, process S202 may include obtaining at least two pieces of first ranging data from the N pieces of first ranging data, performing linear fitting according to the at least two pieces of first ranging data to obtain a first linear function, and excluding the outliers from the N pieces of first ranging data according to the first linear function to obtain the M pieces of first ranging data.

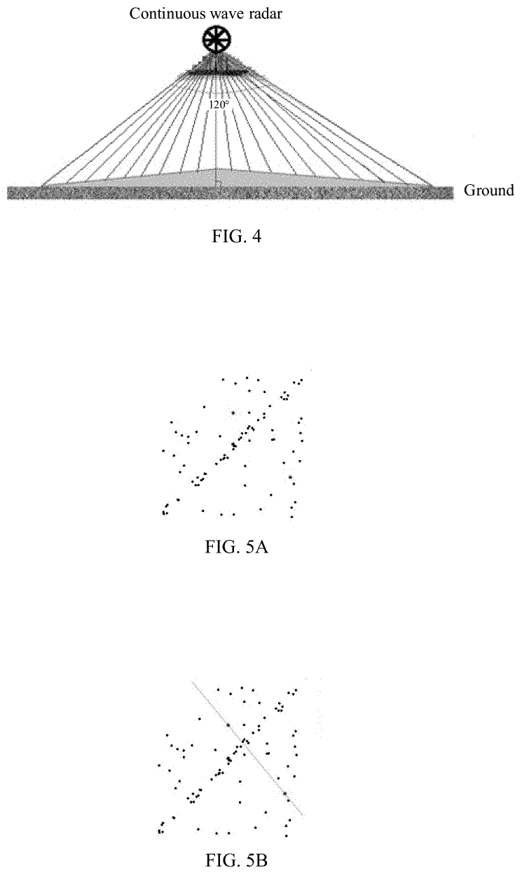

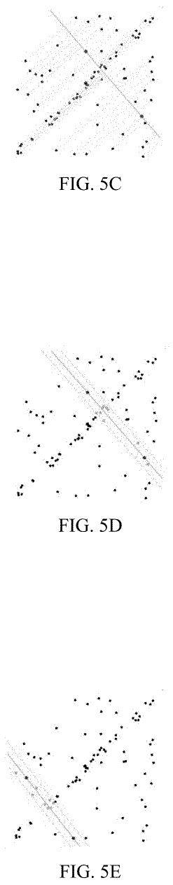

In some embodiments, the at least two pieces of first ranging data may be obtained randomly from the N pieces of first ranging data (FIG. 5A shows the distribution of the N pieces of first ranging data in the XOY coordinate system). The linear fitting may be performed according to the at least two pieces of first ranging data to obtain a linear function, referred to as the first linear function, of the vertical distance with respect to the horizontal distance in the first ranging data.

As shown in FIG. 5B, two pieces of first ranging data (x₁, y₁) and (x₂, y₂) are obtained from the N pieces of first ranging data. A straight line is drawn through the two pieces of first ranging data to obtain the first linear function. The first linear function is represented by:

$$y = \frac{{y}_{2} - {y}_{1}}{{x}_{2} - {x}_{1}} x - \frac{{x}_{1} {y}_{2} - {x}_{2} {y}_{1}}{{x}_{2} - {x}_{1}}$$

After the first linear function is obtained according to the first ranging data, the outliers may be excluded from the N pieces of first ranging data according to the first linear function to obtain the M pieces of first ranging data. In some embodiments, the outliers may include first ranging data having a distance to the straight line corresponding to the first linear function greater than the predetermined distance. That is, in embodiments of the present disclosure, a distance (as shown in FIG. 5C) between each piece of first ranging data and the created straight line may be determined. Then, whether the distance is greater than the predetermined distance may be determined. If the distance is smaller than or equal to the predetermined distance, the first ranging data corresponding to the distance may be determined to belong to the M pieces of first ranging data. If the distance is greater than the predetermined distance, the first ranging data corresponding to the distance may be too different, and the first ranging data corresponding to the distance may be determined to be the outliers and may be excluded.

A distance Pi between an i-th piece of first ranging data (xᵢ, yᵢ) and the created straight line may be represented by the following formula.

$${P}_{i} = \frac{\vert \frac{{y}_{2} - {y}_{1}}{{x}_{2} - {x}_{1}} {x}_{i} - \frac{{x}_{1} {y}_{2} - {x}_{2} {y}_{1}}{{x}_{2} - {x}_{1}} + {y}_{i} \vert}{\sqrt{{( \frac{{y}_{2} - {y}_{1}}{{x}_{2} - {x}_{1}} )}^{2} + 1}}$$

In some other embodiments, process S202 may include performing obtaining at least two pieces of first ranging data from the N pieces of first ranging data for K times, for the at least two pieces of first ranging data obtained each time, performing linear fitting according to the obtained at least two pieces of first ranging data of a current time to obtain a first linear function, excluding the outliers from the N pieces of first ranging data according to the first linear function to obtain a set of first ranging data, and obtaining the M pieces of first ranging data according to obtained K sets of first ranging data. Each time of obtaining the at least two pieces of first ranging data from the N pieces of first ranging data is also referred to as a data extraction. That is, K times of data extraction are performed to obtain K sets of first ranging data each including at least two pieces of first ranging data. Such a set of first ranging data is also referred to as a sample set of first ranging data. Further, a set of first ranging data after the outliers are excluded is also referred to as a processed set of first ranging data.

An example with two pieces of first ranging data being obtained from the N pieces of first ranging data each time is described below.

As shown in FIG. 5B, two pieces of first ranging data are first obtained (e.g., obtained randomly) from the N pieces of first ranging data for a first time. As shown in FIG. 5C, linear fitting is performed according to the two pieces of first ranging data obtained for the first time to obtain a first first linear function. As shown in FIG. 5D, the outliers are excluded from the N pieces of first ranging data according to the first linear function to obtain a first set of first ranging data. The first set of first ranging data may include a plurality of pieces of first ranging data.

Then, two pieces of first ranging data may be obtained (e.g., obtained randomly) from the N pieces of first ranging data for a second time. The linear fitting may be performed according to the two pieces of first ranging data obtained for the second time to obtain a second first linear function. Then, the outliers may be excluded from the N pieces of first ranging data according to the first linear function to obtain a second set of first ranging data. The second set of first ranging data may include a plurality of pieces of first ranging data. The two pieces of first ranging data obtained for the second time may be different from the two pieces of first ranging data obtained for the first time. The above processes are shown in FIG. 5E.

Then, two pieces of first ranging data may be obtained (e.g., obtained randomly) from the N pieces of first ranging data for a third time. The linear fitting may be performed according to the two pieces of first ranging data obtained for the third time to obtain a third first linear function. According to the first linear function, the outliers may be excluded from the N pieces of first ranging data to obtain a third set of first ranging data. The third set of first ranging data may include a plurality of pieces of first ranging data. The two pieces of first ranging data obtained for the third time may be different from the two pieces of first ranging data obtained for first time and the also be different from the two pieces of first ranging data obtained for the second time. The above processes are shown in FIG. 5F.

In the above example, K equals 3. That is, when the number of times to obtain the two pieces of first ranging data is greater than or equal to 3, the process of obtaining the two pieces of first ranging data from the N pieces of first ranging data is stopped.

After the three sets of first ranging data are obtained, according to the first set of first ranging data, the second set of first ranging data, and the third set of first ranging data, the M pieces of first ranging data may be obtained. In some embodiments, a set of first ranging data including the largest number of first ranging data may be determined from the first set of first ranging data, the second set of first ranging data, and the third set of first ranging data to be the M pieces of first ranging data. For example, the first set of first ranging data may include 20 pieces of first ranging data. The second set of first ranging data may include 30 pieces of first ranging data. The third set of first ranging data may include 25 pieces of first ranging data. The 30 pieces of first ranging data of the second set of first ranging data may be determined as the M pieces of first ranging data. Here, M equals 30.

In some embodiments, excluding the outliers from the N pieces of first ranging data according to any one of the first linear functions to obtain a set of first ranging data may include the following processes. The distance of each piece of first ranging data to the straight line corresponding to the any one of the first linear functions may be determined first. Then, whether the distance is greater than the predetermined distance may be determined. If the distance is smaller than or equal to the predetermined distance, the first ranging data corresponding to the distance may be determined to belong to the set of first ranging data. If the distance is greater than the predetermined distance, the first ranging data corresponding to the distance may be quite different, and the first ranging data corresponding to the distance may be an outlier.

In some embodiments, after the M pieces of first ranging data are obtained by the implementations above, whether M is smaller than a first predetermined value may be determined. If M is greater than or equal to a first predetermined value, the M pieces of first ranging data may include sufficient data, which are used to perform the terrain prediction. Then, according to the M pieces of first ranging data, the terrain parameter of the ground may be determined. If M is smaller than the first predetermined value, the M pieces of first ranging data may not be sufficient for performing the terrain prediction. To avoid inaccurate terrain prediction, the ranging data measured by the continuous wave radar may be determined to be invalid.

In some embodiments, determining the terrain parameter of the ground according to the M pieces of first ranging data may include performing linear fitting on the M pieces of first ranging data to obtain a second linear function and determining the terrain parameter of the ground according to the second linear function.

In some embodiments, the linear fitting may be performed on the M pieces of first ranging data by a least square method to obtain a linear function, which is referred to as the second linear function. One piece of first ranging data may include the horizontal distance and the vertical distance.

The second linear function of the vertical distance between the continuous wave radar and the ground ranging point and the horizontal distance between the continuous wave radar and the ground ranging point may be constructed. The second linear function may be represented by formula 1: y=ax+b, where, y is the vertical distance of the continuous wave radar to the ranging point of the ground, x is the horizontal distance of the continuous wave radar to the ranging point of the ground, and a and b may be temporarily unknown. Then, according to the M pieces of first ranging data, the second linear function, and the least square method, a gradient and an intercept of the second linear function may be determined. The M pieces of first ranging data are known. Each piece of first ranging data may include the horizontal distance and the vertical distance of the continuous wave radar to the corresponding ranging point of the ground. The M sets of known x and y may be substituted into formula 1 to determine the gradient (e.g., a) and the intercept (e.g., b) of the second linear function by the least square method.

In some embodiments, a and b may be determined by Klem method, as shown below, where (xᵢ, yᵢ) may be any one of the above M pieces of first ranging data.

$$a = \frac{M {\sum }_{i = 1}^{M} {x}_{i} {y}_{i} - {\sum }_{i = 1}^{M} {x}_{i} {\sum }_{i = 1}^{M} {y}_{i}}{M {\sum }_{i = 1}^{M} {x}_{i}^{2} - {( {\sum }_{i = 1}^{M} {x}_{i} )}^{2}} \\ b = \frac{{\sum }_{i = 1}^{M} {x}_{i}^{2} {\sum }_{i = 1}^{M} {y}_{i} - {\sum }_{i = 1}^{M} {x}_{i} {\sum }_{i = 1}^{M} {x}_{i} {y}_{i}}{M {\sum }_{i = 1}^{M} {x}_{i}^{2} - {( {\sum }_{i = 1}^{M} {x}_{i} )}^{2}}$$

Embodiments of the present disclosure are not limited to the least square method and may use a wave filter method.

If the terrain parameter of the ground includes the slope of the ground, the slope of the ground may be determined according to the gradient of the second linear function. For example, the larger the gradient is, the larger the slope of the ground is, and the smaller the gradient is, the smaller the slope of the ground is. In some embodiments, an arctangent value of the gradient may be determined as the slope of the ground.

In some embodiments, the slope of the ground may be used to guide subsequent actions performed by the UAV.

If the terrain parameter of the ground includes the height value of the continuous wave radar to the ground directly below, according to the intercept of the second linear function, the height value of the continuous wave radar to the ground directly below may be determined. For example, the intercept of the second linear function may be determined as the height value of the continuous wave radar to the ground directly below.

In some embodiments, the height value of the continuous wave radar to the ground directly below may be used to avoid an obstacle for the UAV, for example, to avoid hitting crops on the ground. In addition, the height value may be used to spray accurately for the UAV, because determined height spray may be required when the UAV sprays.

If the terrain parameter of the ground includes the flatness of the ground, according to the M pieces of first ranging data and the second linear function, a residual of the second linear function corresponding to each piece of the M pieces of first ranging data may be determined. Then, the flatness of the ground may be determined according to the residuals of the second linear functions corresponding to the M pieces of first ranging data.

The residual of the second linear function corresponding to each piece of first ranging data may be obtained by the following formula.

eᵢ=yᵢ−yᵢ′

where eᵢ denotes a residual of the second linear function corresponding to an i-th piece of first ranging data of the M pieces of first ranging data, yᵢ denotes a vertical distance of the i-th piece of first ranging data of the M pieces of first ranging data, yᵢ′ denotes a value of y obtained by substitute the horizontal distance xᵢ of the i-th pieces of the first ranging data of the M pieces of first ranging data as a variable x into the second linear function, that is, yᵢ′=axᵢ+b.

In some embodiments, a sum of squares of the residuals of the second linear functions corresponding to the M pieces of first ranging data may be determined as the flatness of the ground. The greater the sum of squares of the residuals is, the more uneven the ground is. The smaller the sum of squares of the residuals is, the flatter the ground is. For example, the flatness of the ground is:

Σᵢ₌₁^{M}eᵢ².

In some embodiments, after the flatness of the ground is determined, the flatness may be used in a solution of a height determination and an obstacle avoidance for the UAV.

In some embodiments, according to the vertical distance of the continuous wave radar corresponding to each piece of the M pieces of first ranging data to the ranging point, a median vertical distance may be determined. That is, a median value of y₁, y₂, y₃, . . . , y_{M-2}, y_{M-1}, y_{M} may be determined, and the median value may be referred to as the median vertical distance. For example, M equals 7, and 1.2, 1.3, 1.3, 1.5, 1.6, 1.7, and 1.8 may be obtained by sorting y₁, y₂, y₃, y₄, y₅, y_{6,} and y₇ according to magnitude. Thus, 1.5 is the median value. Whether a difference between the intercept of the second linear function and the median vertical distance is smaller than the second predetermined value may be determined. If the difference is smaller than the second predetermined value, the terrain parameter of the ground is determined according to the second linear function. If the difference is greater than or equal to the second predetermined value, this means that the ranging data measured by the continuous wave radar may not be suitable for the terrain prediction, and hence determining the terrain parameter of the ground according to the second linear function is not performed.

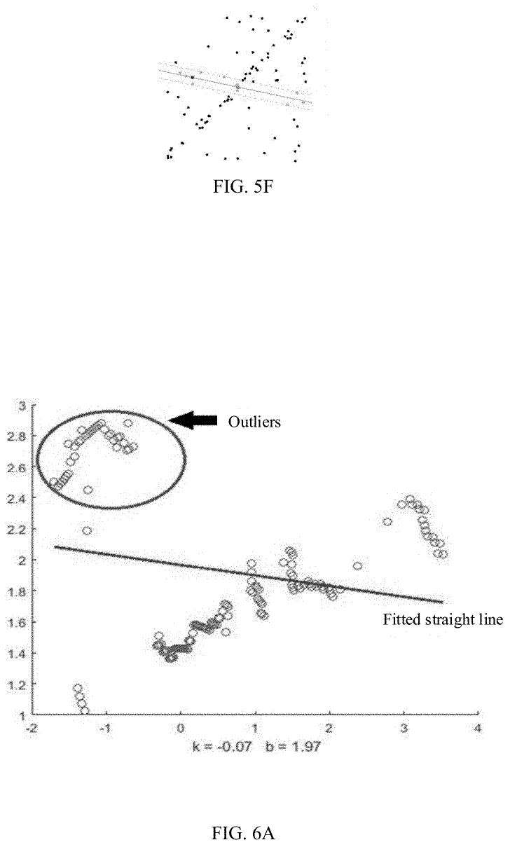

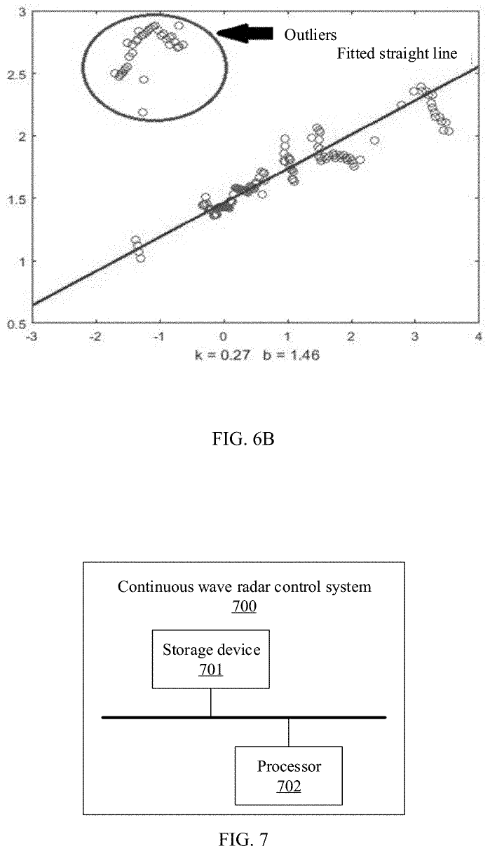

In summary, if the outliers are not excluded from the N pieces of first ranging data, the fitted straight line obtained by linearly fitting the N pieces of first ranging data including the outliers using the least square method is shown in FIG. 6A. The terrain parameter of the ground obtained using the fitted straight line in FIG. 6A may not be accurate. On the other hand, FIG. 6B shows the fitted straight line obtained by linearly fitting the first ranging data after the outliers are excluded from the N pieces of first ranging data consistent with the disclosure using the least square method. The terrain parameter of the ground obtained using the fitted straight line in FIG. 6B is more accurate.

In some other embodiments, after the N pieces of first ranging data are obtained, the outliers may not be excluded. Rather, the N pieces of first ranging data may be linearly fitted by a weighted least square method to obtain a third linear function. According to the third linear function, the terrain parameter of the ground may be determined. Therefore, the interference on the continuous wave radar when obtaining the ranging data may be eliminated by using the weighted least square method to improve the precision of the linear fitting and improve the accuracy of the terrain prediction.

In some embodiments, performing weighted least square linear fitting on the N pieces of first ranging data to obtain the third linear function includes the following processes.

The third linear function of the vertical distance of the continuous wave radar and the ranging point of the ground and the horizontal distance of the continuous wave radar and the ranging point of the ground may be constructed. The third linear function may be represented by formula 2:

y=ax+b.

where y denotes the vertical distance of the continuous wave radar and the ranging point of the ground, x denotes the horizontal distance of the continuous wave radar and the ranging point of the ground, and a and b are unknown. According to the N pieces of first ranging data and the third linear function, yᵢ′ corresponding to xᵢ may be determined. yᵢ′ may be the value of y (i.e., the fitted vertical distance) obtained by substituting xᵢ as the variable x into the third linear function. xᵢ may be the horizontal distance of the i-th piece of the N pieces of first ranging data.

After the fitted vertical distance corresponding to the horizontal distance of each piece of the N pieces of first ranging data is determined, the residual of the third linear function corresponding to each piece of first ranging data may be determined. The residual corresponding to each piece of first range data may be a function of gradient and intercept of the linear function, for example, e=yᵢ−axᵢ−b. According to the residual and weighted coefficient of the residual corresponding to each piece of first ranging data, a weighted sum of squares of the residuals corresponding to the N pieces of first ranging data may be determined. The weighted sum of squares of the residuals may be represented by formula 3:

Q=Σᵢ₌₁^{N}wᵢ(yᵢ−axᵢ−b)².

where Q denotes the weighted sum of squares of the residuals, wᵢ denotes the weighted coefficient of the residual corresponding to the i-th piece of first ranging data.

In some embodiments, after the weighted sum of squares of the residuals is obtained, according to the weighted sum of squares of the residuals, the value of the gradient and the value of the intercept of the linear function may be determined. In some embodiments, according to the first derivative of the weighted sum of squares of the residuals to the gradient being equal to the first predetermined value, and the first derivative of the weighted sum of squares of the residuals to the intercept being equal to the second predetermined value, the value of the gradient and the value of the intercept of the linear function may be determined.

To cause Q to be the smallest and the values of a and b to be optimal, the first predetermined value and the second predetermined value may be set to zero. Correspondingly, the first derivative of the weighted sum of squares of the residuals (Q) to the gradient (a) may be equal to zero, and the first derivative of the weighted sum of squares of the residuals (Q) to the intercept (b) may be equal to zero, which may be represented by formula 4:

$$\frac{\partial Q}{\partial a} = 2 {\sum }_{i = 1}^{N} {w}_{i} ( {y}_{i} - a {x}_{i} - b ) ( - {x}_{i} ) = 0 , \\ \frac{\partial Q}{\partial b} = 2 {\sum }_{i = 1}^{N} {w}_{i} ( {y}_{i} - a {x}_{i} - b ) ( - 1 ) = 0 .$$

According to formula 4, an estimated value â of a and an estimated value \hat{b} of b may be obtained by formula 5:

$$â = \frac{{Σ}_{i = 1}^{N} {w}_{i} {x}_{i} {y}_{i} - {Σ}_{i = 1}^{N} {w}_{i} {x}_{i} {Σ}_{i = 1}^{N} {w}_{i} {y}_{i}}{{Σ}_{i = 1}^{N} {w}_{i} {x}_{i}^{2} - {( {Σ}_{i = 1}^{N} {w}_{i} {x}_{i} )}^{2}} , \\ \hat{b} = \frac{{Σ}_{i = 1}^{N} {w}_{i} {x}_{i}^{2} {Σ}_{i = 1}^{N} {w}_{i} {y}_{i} - {Σ}_{i = 1}^{N} {w}_{i} {x}_{i} {Σ}_{i = 1}^{N} {w}_{i} {x}_{i} {y}_{i}}{{Σ}_{i = 1}^{N} {w}_{i} {x}_{i}^{2} - {( {Σ}_{i = 1}^{N} {w}_{i} {x}_{i} )}^{2}} .$$

In some embodiments, â may be used as the value of the gradient a of the third linear function, and \hat{b} may be used as the value of the intercept b of the third linear function.

In some embodiments, if the terrain parameter of the ground includes the flatness, according to the gradient a of the third linear function, the flatness of the ground may be determined.

If the terrain parameter of the ground includes the height value of the continuous wave radar to the ground directly below, according to the intercept of the third linear function, the height value of the continuous wave radar to the ground directly below may be determined.

If the terrain parameter of the ground includes the flatness, according to the value of Q, the flatness of the ground may be determined. For example, the value of a (e.g., â) and the value of b (e.g., \hat{b}) may be substituted into formula 2 to obtain the value of Q. The greater the value of Q is, the more uneven the ground is. The smaller the value of Q is, the flatter the ground is.

In some embodiments, formula 3 and formula 5 may be pre-stored, the obtained N pieces of first ranging data may be substitute into the pre-stored formula 5 to obtain â and \hat{b}. The slope of the ground may be determined according to â. Then, the obtained a and b may be substituted into formula 3 to obtain Q. According to the value of Q, the flatness of the ground may be determined.

In some embodiments, the weighted coefficient of the residual corresponding to each piece of first ranging data may be the same, that is, the value of i may be different, however, wᵢ may be the same, for example, wᵢ may be equal to 1. In some other embodiments, wᵢ may be equal to or 1/N. The sum of the weighted coefficients of the residuals corresponding to the N pieces of first ranging data may be equal to 1.

In some embodiments, since the error of the ranging data obtained by the ranging of the continuous wave radar may become larger as the distance increases, weight distribution may need to be performed on the first ranging data corresponding to the rotation angle of the continuous wave radar.

In some embodiments, the weight coefficient of the residual corresponding to each piece of first ranging data may be a trigonometric function about the rotation angle of the continuous wave radar corresponding to the first ranging data, which may be represented by formula 6:

$${w}_{i} = 1 - ( \frac{{k}_{i} - {k}_{m i d}}{{k}_{m ax} - {k}_{m i n}} ) .$$

where k_{mid} denotes a median value in the predetermined angle range, kₘᵢₙ denotes a minimum value in the predetermined angle range, kₘₐₓ denotes a maximum value in the predetermined angle range, and kᵢ denotes the rotation angle of the continuous wave radar corresponding to the i-th piece of first ranging data. For example, the predetermined angle range may be [−60°, 60°], a total of 120°. k corresponding to −60° may be equal to 1, k corresponding to −59° may be equal to 2, and so on so forth. kₘₐₓ may be equal to 120, k_{mid} may be equal to 60 or 61, and kₘᵢₙ may be equal to 1.

In some embodiments, the sum of the weighted coefficients of the residuals corresponding to the N pieces of first ranging data may be equal to 1. Thus, normalization processing may be performed on the trigonometric function. Therefore, the weighted coefficients of the residuals may be represented by formula 7:

$${w}_{i} = \frac{1 - ( \frac{{k}_{i} - {k}_{m i d}}{{k}_{m ax} - {k}_{m i n}} )}{{Σ}_{i = 1}^{N Σ} ( 1 - ( \frac{{k}_{i} - {k}_{m i d}}{{k}_{ma x} - {k}_{m i n}} ) )} .$$

In some other embodiments, the weight coefficient of the residual corresponding to each piece of first ranging data may be a Gaussian function of the rotation angle of the continuous wave radar corresponding to the first ranging data, which may be represented by formula 8:

$${w}_{i} = \frac{1}{σ \sqrt{2 π}} {e}^{- \frac{{( {x}_{i} - μ )}^{2}}{2 {σ}^{2}}} .$$

where xᵢ is the horizontal distance of the i-th piece of the N pieces of first ranging data, σ and μ are constants, μ denotes an average value of x₁ to x_{N}, and a denotes σ variance of x₁ to x_{N}.

The shape of the function may be adjusted according to the variance. The value of the variance may be predetermined according to the actual needs.

In some embodiments, the sum of weight coefficients of the residuals corresponding to the N pieces of first ranging data may be equal to 1. Then, Gaussian function may need to be normalized. Thus, the weight coefficient of the residual may be represented by formula 9:

$${w}_{i} = \frac{\frac{1}{σ \sqrt{2 π}} {e}^{- \frac{{( {x}_{i} - μ )}^{2}}{2 {σ}^{2}}}}{{Σ}_{i = 1}^{N} \frac{1}{σ \sqrt{2 π}} {e}^{- \frac{{( {{x}_{i}}^{-} μ )}^{2}}{2 {σ}^{2}}}} .$$

In some other embodiments, the weight coefficient of the residual corresponding to each piece of first ranging data may be an error function of the rotation angle of the continuous wave radar corresponding to the first ranging data, which may be represented by formula 10:

$${w}_{i} = \frac{1}{{e}_{i}^{2}} .$$

where eᵢ=yᵢ−yᵢ′, eᵢ is the residual of the third linear function corresponding to the i-th piece of the N pieces of first ranging data, yᵢ is the vertical distance of the i-th piece of the N pieces of first ranging data, yᵢ′ is the value of y obtained by substituting the horizontal distance xᵢ of the i-th piece of the N pieces of first ranging data as variable x into the third linear function, that is, yᵢ′=axᵢ+b.

The smaller the error is, the greater the weight coefficient is. The larger the error is, the smaller the weight coefficient is.

In some embodiments, the sum of weight coefficients of the residuals corresponding to the N pieces of first ranging data may be equal to 1, the error function may be normalized. Thus, the weight coefficient of the residual may be represented by formula 10:

$${w}_{i} = \frac{\frac{1}{{e}_{i}^{2}}}{{Σ}_{i = 1}^{N} \frac{1}{{e}_{i}^{2}}} .$$

In some embodiments, the continuous wave radar may include an electromagnetic continuous wave radar or a laser continuous wave radar.

Embodiments of the present disclosure further provide a computer-readable storage medium. The computer-readable storage medium may store program instructions. When the program instructions are executed, some or all processes of the terrain prediction method of the continuous wave radar consistent with the disclosure, such as the example methods described above in connection with FIG. 2 may be included.

FIG. 7 is a schematic structural diagram of a control system 700 of the continuous wave radar according to some embodiments of the present disclosure. As shown in FIG. 7, the control system 700 of the continuous wave radar includes a storage device 701 and a processor 702 connected to each other via a bus. The storage device 701 may include a read-only memory and a random-access memory and may be configured to provide instructions and data to the processor 702. A part of the storage device 701 may include a non-volatile random-access memory.

The storage device 701 may be configured to store program codes.

The processor 702 may be configured to call the program codes that, when being executed, cause the processor 702 to obtain N pieces of first ranging data that are obtained by the continuous wave radar measuring a distance to the ground during rotation, excluding outliers from the N pieces of first ranging data to obtain M pieces of first ranging data, and determining a terrain parameter of the ground according to the N pieces of first ranging data. The N pieces of first ranging data can be obtained when a rotation angle of the continuous wave radar is in a predetermined angle range. The terrain parameter may include at least one of a slope, a flatness, or a height value of the continuous wave radar to the ground directly below.

In some embodiments, the first ranging data may include the horizontal distance and the vertical distance of the continuous wave radar to the ranging point of the ground. The ranging point of the ground may change as the rotation angle of the continuous wave radar changes.

In some embodiments, the processor 702 may be configured to obtain at least two pieces of first ranging data from the N pieces of first ranging data, perform linear fitting on the at least two pieces of first ranging data to obtain the first linear function, and according to the first linear function, exclude the outliers of the N pieces of first ranging data to obtain the M pieces of first ranging data.

In some embodiments, the processor 702 may be configured to obtain at least two pieces of first ranging data from the N pieces of first ranging data for K times, for the at least two pieces of first ranging data obtained each time, perform linear fitting on the at least two pieces of first ranging data obtained of the current time to obtain the first linear function, according to the first linear function, exclude the outliers of the N pieces of first ranging data to obtain a set of first ranging data, and according to K sets of first ranging data, obtain the M pieces of first ranging data. The at least two pieces of first ranging data obtained each time may be different.

In some embodiments, the processor 702 may be configured to determine a set of first ranging data with a largest number of first ranging data as the M pieces of first ranging data from the K sets of first ranging data.

In some embodiments, the outliers may include the first ranging data having distances to the straight line corresponding to the first linear function greater than the predetermined distance.

In some embodiments, the processor 702 may be configured to determine the terrain parameter of the ground according to the M pieces of first ranging data when M is greater than or equal to the first predetermined value.

In some embodiments, the processor 702 may be configured to perform linear fitting on the M pieces of first ranging data to obtain the second linear function, and determine the terrain parameter of the ground according to the second linear function.

In some embodiments, the processor 702 may be configured to determine the median vertical distance according to the vertical distance of the continuous wave radar corresponding to each piece of the M pieces of first ranging data to the ranging point. If the difference between the intercept of the second linear function and the median vertical distance is smaller than the second predetermined value, the terrain parameter of the ground may be determined according to the second linear function.

In some embodiments, the terrain parameter may include the slope. The processor 702 may be configured to determine the slope of the ground according to the gradient of the second linear function.

In some embodiments, the processor 702 may be configured to determine the arc tangent value of the gradient as the slope of the ground.

In some embodiments, the terrain parameter may include the height value of the continuous wave radar to the ground directly below. The processor 702 may be configured to determine the height value of the continuous wave radar to the ground directly below according to the intercept of the second linear function.

In some embodiments, the terrain parameter may include the flatness. The processor 702 may be configured to, according to the M pieces of first ranging data and the second linear function, determine the residual of the second linear function corresponding to each piece of the M pieces of first ranging data, and according to the residual of the second linear function corresponding to the M pieces of first ranging data, determine the flatness of the ground.

In some embodiments, the processor 702 may be configured to determine the sum of the residuals of the second linear function corresponding to the M pieces of first ranging data as the flatness of the ground.

In some embodiments, the processor 702 may be configured to obtain the T pieces of second ranging data when the continuous wave radar performs ranging on the ground during rotation, and obtain the N pieces of first ranging data according to the T pieces of second ranging data. The T pieces of second ranging data may include all the pieces of ranging data by the continuous wave radar performing ranging on the ground when the rotation angle is in the predetermined angle range. T may include an integer greater than or equal to N.

In some embodiments, the processor 702 may be configured to determine the N pieces of first ranging data according to the T pieces of second ranging data and the effective ranging condition.

The effective ranging condition may include being smaller than or equal to the longest distance and greater than or equal to the shortest distance.

In some embodiments, the processor 702 may be configured to determine the N pieces of second ranging data satisfying the effective ranging condition from the T pieces of second ranging data and determine the N pieces of first ranging data according to the N pieces of second ranging data.

In some embodiments, the processor 702 may be configured to determine the N pieces of second ranging data as the N pieces of first ranging data or perform smoothing on the N pieces of second ranging data to obtain the N pieces of first ranging data.

In some embodiments, the processor 702 may be configured to sort the N pieces of second ranging data according to the order of the rotation angle of the continuous wave radar corresponding to the second ranging data, determine the first piece of second ranging data as the first piece of first ranging data and the N-th piece of second ranging data as the N-th piece of first ranging data, and determine the average value of the (j−1)-th piece of second ranging data, the j-th piece of second ranging data, and the (j+1)-th piece of second ranging data to be the j-th piece of first ranging data. j is an integer greater than or equal to 2 and smaller than or equal to N−1.

In some embodiments, the processor 702 may be configured to obtain all the pieces of second ranging data by the continuous wave radar performing ranging on the ground when rotating one revolution and the rotation angle of the continuous wave radar corresponding to each piece of second ranging data, and according to the predetermined angle range, obtain T pieces of second ranging data corresponding to the rotation angle of the continuous wave radar when being located in the predetermined angle range.

In some embodiments, the control system of the continuous wave radar may be configured to execute the technical solution of method embodiments. The implementation principle and the technical effects are similar, which are not repeated.

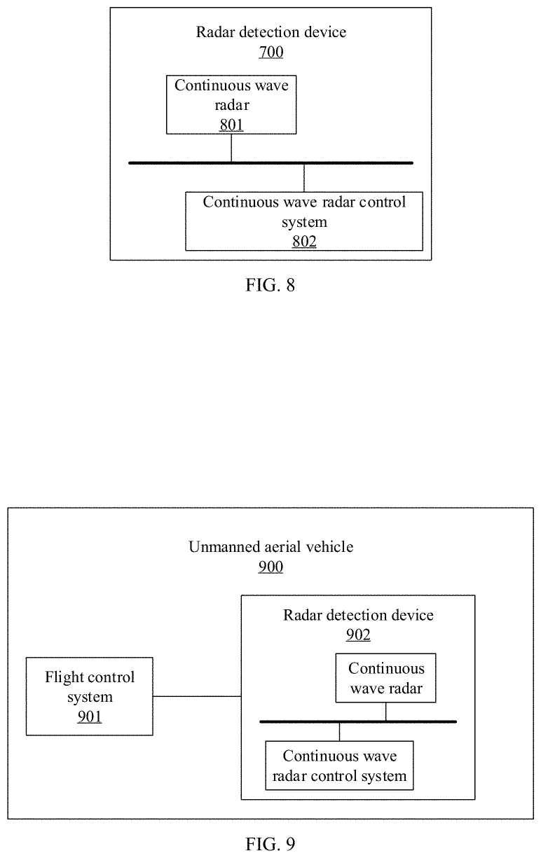

FIG. 8 is a schematic structural diagram of a radar detection device 800 according to some embodiments of the present disclosure. As shown in FIG. 8, the radar detection device 800 includes a continuous wave radar 801 and a control system 802 of the continuous wave radar. The control system 802 of the continuous wave radar may be communicatively connected to the continuous wave radar 801. The control system 802 of the continuous wave radar may be, e.g., the control system shown in FIG. 7. Correspondingly, a method consistent with the disclosure, such as one of the example methods described above in connection with FIG. 2 may be executed. The implementation principle and the technical effect may be similar, which are not repeated here.

FIG. 9 is a schematic structural diagram of a UAV 900 according to some embodiments of the present disclosure. The UAV 900 includes a vehicle stand (not shown in the drawing), a flight control system 901, and a radar detection device 902. The radar detection device 902 may be, e.g., the radar detection device shown in FIG. 8 and may be configured to execute FIG. 2. The implementation principle and technical effects are similar, which are not repeated here. The continuous wave radar of the radar detection device 902 is carried at the vehicle stand. The flight control system 901 may be communicatively connected to the radar detection device 902 to obtain the terrain parameter. The flight control system 901 may be configured to control the UAV 900 according to the terrain parameter.

In some embodiments, if the terrain parameter of the ground includes the slope of the ground, the flight control system 901 may control the subsequent action of the UAV 900 according to the slope of the ground.

In some embodiments, if the terrain parameter of the ground includes the flatness of the ground, the flight control system 901 may control the determined height of the UAV 900 and/or control the UAV 900 to avoid the obstacle according to the flatness of the ground.

In some embodiments, if the terrain parameter of the ground includes the height value of the continuous wave radar to the ground directly below, the flight control system 901 may perform the obstacle avoidance according to the height value of the continuous wave radar to the ground directly below. For example, the UAV 900 may avoid hitting the crops on the ground. In addition, the UAV 900 may be controlled to perform precision spray, because even height spray may be needed when the UAV 900 sprays.

Those of ordinary skill in the art may understand that all or part of the processes of embodiments of the present disclosure may be implemented by a program instructing relevant hardware. The program may be stored in a computer-readable storage medium. When the program is executed, the processes of method embodiments may be executed. The storage medium includes a medium of a read-only memory (ROM), a random access memory (RAM), a magnetic disk, an optical disk, etc., which can store program codes.

Embodiments of the present disclosure are only used to illustrate the technical solutions of the present disclosure, but not to limit it. Although the present disclosure has been described in detail with reference to the above embodiments, those of ordinary skill in the art should understand that modifications may be made to the technical solution of embodiments of the present disclosure or equivalent replacements may be performed on part or all technical features. These modifications or replacements do not cause the related technical solution to depart from the essence of the scope of technical solutions of embodiments of the present disclosure.

What is claimed is:

1. A terrain prediction method comprising:
obtaining N pieces of ranging data obtained by a continuous wave radar performing ranging on ground during rotation and when a rotation angle of the continuous wave radar is in a predetermined angle range, N being an integer greater than 1;
excluding outliers from the N pieces of ranging data to obtain M pieces of ranging data, M being a positive integer smaller than N; and
determining a terrain parameter of the ground according to the M pieces of ranging data, the terrain parameter including at least one of a slope, a flatness, or a height value of the continuous wave radar to the ground directly below.

2. The method of claim 1, wherein one piece of ranging data includes:
a horizontal distance and a vertical distance of the continuous wave radar to a ranging point of the ground, the ranging point of the ground changing as the rotation angle of the continuous wave radar changes.

3. The method of claim 1, wherein excluding the outliers from the N pieces of ranging data to obtain the M pieces of ranging data includes:
obtaining at least two pieces of ranging data from the N pieces of ranging data;
performing linear fitting on the at least two pieces of ranging data to obtain a linear function; and
excluding the outliers from the N pieces of ranging data according to the linear function to obtain the M pieces of ranging data.

4. The method of claim 3, wherein the outliers include the ranging data with distance to a straight line corresponding to the linear function greater than a predetermined distance.

5. The method of claim 1, wherein excluding the outliers from the N pieces of ranging data to obtain the M pieces of ranging data includes:
performing obtaining at least two pieces of ranging data from the N pieces of ranging data for K times to obtain K sample sets of ranging data, K being an integer greater than 1;
obtaining K processed sets of ranging data based at least on the K sample sets of ranging data, including, for each one of the K sample sets of ranging data:
performing linear fitting on the at least two pieces of ranging data in the one sample set of ranging data to obtain a linear function; and
excluding the outliers from the N pieces of ranging data according to the linear function to obtain a processed set of ranging data; and
obtaining the M pieces of ranging data according to the K processed sets of ranging data.

6. The method of claim 5, wherein obtaining the M pieces of ranging data according to the K processed sets of ranging data includes:
determining, from the K processed sets of ranging data, a processed set of ranging data with a largest number of pieces of ranging data to be the M pieces of ranging data.

7. The method of claim 1, wherein determining the terrain parameter of the ground according to the M pieces of ranging data includes:
in response to M being greater than or equal to a predetermined value, determining the terrain parameter of the ground according to the M pieces of ranging data.

8. The method of claim 1, wherein determining the terrain parameter of the ground according to the M pieces of ranging data includes:
performing linear fitting on the M pieces of ranging data to obtain a linear function; and
determining the terrain parameter of the ground according to the linear function.

9. The method of claim 8, wherein determining the terrain parameter of the ground according to the linear function includes:
determining a median vertical distance according to vertical distances of the continuous wave radar to ranging points corresponding to the M pieces of ranging data; and
in response to a difference between an intercept of the linear function and the median vertical distance being smaller than a predetermined value, determining the terrain parameter of the ground according to the linear function.

10. The method of claim 8, wherein:
the terrain parameter includes the slope; and
determining the terrain parameter of the ground according to the linear function includes determining the slope of the ground according to a gradient of the linear function.

11. The method of claim 10, wherein determining the slope of the ground according to the gradient of the linear function includes:
determining an arctangent of the gradient as the slope of the ground.

12. The method of claim 8, wherein:
the terrain parameter includes the height value of the continuous wave radar to the ground directly below; and
determining the terrain parameter of the ground according to the linear function includes determining the height value of the continuous wave radar to the ground directly below according to the intercept of the linear function.

13. The method of claim 8, wherein:
the terrain parameter includes the flatness; and
determining the terrain parameter of the ground according to the linear function includes:
determining residuals of the linear function corresponding to the M pieces of ranging data; and
determining the flatness of the ground according to the residuals.

14. The method of claim 13, wherein determining the flatness of the ground according to the residuals includes:
determining a sum of the residuals as the flatness of the ground.

15. The method of claim 1, wherein:
the N pieces of ranging data are N pieces of first ranging data; and
obtaining the N pieces of first ranging data includes:
obtaining T pieces of second ranging data of the continuous wave radar performing ranging on the ground during the rotation and when the rotation angle is in the predetermined angle range, T being an integer greater than or equal to N; and
obtaining the N pieces of first ranging data according to the T pieces of second ranging data.

16. The method of claim 15, wherein obtaining the N pieces of first ranging data according to the T pieces of second ranging data includes:
determining the N pieces of first ranging data according to the T pieces of second ranging data and an effective ranging condition, the effective ranging conduction including being smaller than or equal to a maximum predetermined distance and greater than or equal to a minimum predetermined distance.

17. The method of claim 16, wherein determining the N pieces of first ranging data according to the T pieces of second ranging data and the effective ranging condition includes:
determining N pieces of second ranging data from the T pieces of second ranging data, the N pieces of second ranging data satisfying the effective ranging condition; and
determining the N pieces of first ranging data according to the N pieces of second ranging data.

18. The method of claim 17, wherein determining the N pieces of first ranging data according to the N pieces of second ranging data includes:
determining the N pieces of second ranging data as the N pieces of first ranging data; or
performing smoothing on the N pieces of second ranging data to obtain the N pieces of first ranging data.

19. The method of claim 18, wherein performing smoothing on the N pieces of second ranging data to obtain the N pieces of first ranging data includes:
sorting the N pieces of second ranging data according to an order of rotation angles of the continuous wave radar corresponding to the N pieces of second ranging data;
determining a first piece of the sorted N pieces of second ranging data as a first piece of the N pieces of first ranging data and an N-th piece of the sorted N pieces of second ranging data as an N-th piece of the N pieces of first ranging data; and
determining an average value of a (j−1)-th piece of the sorted N pieces of second ranging data, a j-th piece of the sorted N pieces of second ranging data, and a (j+1)-th piece of the sorted N pieces of second ranging data as a j-th piece of the N pieces of first ranging data, j being an integer greater than or equal to 2 and smaller than or equal to N−1.

20. The method of claim 15, wherein obtaining the T pieces of second ranging data includes:
obtaining all pieces of second ranging data of the continuous wave radar performing ranging on the ground with the rotation of one revolution and the rotation angles of the continuous wave radar corresponding to the all pieces of second ranging data; and
according to the predetermine angle range, obtaining the T pieces of second ranging data corresponding to the rotation angles of the continuous wave radar in the predetermine angle range.
